(19) United States
(12) Patent Application Publication
(10) Pub. No.: US 2017/0138503 A1
(43) Pub. Date: May 18, 2017

(54) MOVABLE MAGNET ACTUATOR VALVE WITH A POLE PIECE

(71) Applicant: FLUID AUTOMATION SYSTEMS S.A., Versoix (CH)

(72) Inventor: Raphael ALVAREZ, Nyon (CH)

(73) Assignee: FLUID AUTOMATION SYSTEMS S.A., Versoix (CH)

(21) Appl. No.: 15/323,483

(22) PCT Filed: Jul. 10, 2015
(86) PCT No.: PCT/EP2015/065821

§ 371 Date: Jan. 3, 2017

Related U.S. Application Data
(60) Provisional application No. 62/024,089, filed on Jul. 14, 2014.

(51) Int. Cl. F16K 31/08; F16K 31/06

(52) U.S. Cl. CPC F16K 31/082; F16K 31/0675

(57) ABSTRACT

A movable magnet actuator valve (100-1800) includes a valve body (110) comprised of a first fluid port (112) and a second fluid port (114-1814), an orifice (118-1818) that fluidly couples the first fluid port (112-1812) and the second fluid port (114-1814), a coil assembly (130-1830) coupled to the valve body (110) and adapted to carry a current that forms a current induced magnetic field. The movable magnet actuator valve (100-1800) also includes a magnet assembly (140-1840) disposed in the coil assembly (130-1830) and adapted to move linearly in the coil assembly (130-1830) to selectively press against the orifice (118-1818), and a pole piece (150-1850) adapted to form a pole force (Fo) on the magnet assembly (140-1840).

### TECHNICAL FIELD

The embodiments described below relate to valves and, more particularly, to movable magnet actuator valves with a pole piece.

### BACKGROUND

Valves typically use a bias spring that presses a valve member to a default position. For example, a 2-port normally closed (NC) valve utilizes the bias spring to press the valve member into a seat to fluidly decouple the two ports. An actuator in the NC valve moves the valve member away from the seat to open the NC valve so that fluid can flow between the two ports. The actuators are usually electromagnetic or pneumatic. An electromagnetic actuator can have a coil (e.g., a solenoid) that surrounds a movable magnet that is coupled to the valve member. Current in the coil induces a magnetic field that pulls the movable magnet and the valve member away from the valve seat. When the current is turned off, the bias spring presses the valve member back into the valve seat.

The bias springs have undesirable characteristics. For example, due to unavoidable variations or tolerances in the bias spring, a maximum and a minimum bias force can vary considerably. In the default position, the bias spring is pressing the valve member with the minimum bias force. The minimum bias force must be sufficient to prevent the fluid from leaking through the orifice. The maximum bias force is present when the valve member is fully displaced away from the seat by the actuator. A test is often done after the valve is fully assembled to measure the maximum bias force and a corresponding fluid flow rate. Sometimes the tests show that, when the valve is actuated, the maximum bias force is causing the valve member to not fully open thereby restricting the fluid flow. That is, the actuator is unable to fully compress the bias spring.

The valves can use a stationary bias magnet to provide the bias force that presses the valve member into the seat. In such an arrangement, the bias magnet can be disposed near the seat to pull the movable magnet and the valve member into the seat. A second bias magnet can also be employed at the other end of the movable magnet to push the valve member into the seat. However, the bias magnets can interfere with the coils or solenoids and add to fault tolerances (e.g., increase the likelihood of a fault) of the valve. The biasing magnets also add to the complexity of the valve.

Magnetic circuits can be used to provide the biasing force. For example, it is known in art that a magnet disposed in a cylinder comprised of magnetic material will have a reluctance force that tends to move the movable magnet towards the center of the cylinder. Actuators have been developed that employ this phenomenon. In contrast to actuators, valves must necessarily counter fluid forces such a pressure differentials on the valve member. In addition, the valves are typically required to meet low power requirements in the open position. For example, valves with movable magnet members may be required to remain open with minimal current to the coils even though the fluid forces tend to bias the valve member to the closed position.

Accordingly, there is a need for a movable magnet actuator valve with a pole piece.

### SUMMARY

A movable magnet actuator valve is provided. According to an embodiment, the movable magnet actuator valve comprises a valve body comprised of a first fluid port and a second fluid port, an orifice that fluidly couples the first fluid port and the second fluid port, and a coil assembly coupled to the valve body and adapted to carry a current that forms a current induced magnetic field. The movable magnet actuator valve further comprises a magnet assembly disposed in the coil assembly and adapted to move linearly in the coil assembly to selectively press against the orifice and a pole piece adapted to form a pole force on the magnet assembly.

A method of controlling fluid through a movable magnet actuator valve is provided. According to an embodiment, the method comprises providing a first orifice that fluidly couples a first fluid port and a second fluid port on the movable magnet actuator valve, forming a current induced magnetic field that applies a current induced force to a magnet assembly to displace the magnet assembly away from the first orifice, and forming a pole force on the magnet assembly with a pole piece that retains the magnet assembly in a position displaced away from the first orifice.

A method of forming a movable magnet actuator valve is provided. According to an embodiment, the method is comprised of providing an orifice that fluidly couples a first fluid port and a second fluid port on the movable magnet actuator valve, providing a magnet assembly that is movable relative to the orifice to selectively fluidly couple the first fluid port and the second fluid port. The method further comprises applying a pole force to the magnet assembly and measuring the pole force while positioning the magnet assembly.

### ASPECTS

According to an aspect, a movable magnet actuator valve (100-1800) comprises a valve body (110) comprised of a first fluid port (112-1812) and a second fluid port (114-1814), an orifice (118-1818) that fluidly couples the first fluid port (112-1812) and the second fluid port (114-1814), a coil assembly (130-1830) coupled to the valve body (110) and adapted to carry a current that forms a current induced magnetic field, a magnet assembly (140-1840) disposed in the coil assembly (130-1830) and adapted to move linearly in the coil assembly (130-1830) to selectively press against the orifice (118-1818), and a pole piece (150-1850) adapted to form a pole force (Fo) on the magnet assembly (140-1840).

Preferably, the movable magnet actuator valve (100-1800) further comprises a magnetic circuit (120-1820) surrounding the magnet assembly (140-1840), the magnetic circuit (120-1820) adapted to induce a reluctance force (Fr) on the magnet assembly (140-1840).

Preferably, the pole force (Fo) holds the magnet assembly (140-1840) away from the orifice (118-1818) when the current in the coil assembly (130-1830) is about zero.

Preferably, the movable magnet actuator valve (100-1800) further comprises a second orifice (1618b) fluidly coupled to the second fluid port (1614) wherein the pole force (Fo) presses the magnet assembly (1640) against the second orifice (1618b) when the current in the coil assembly (1630) is about zero.

Preferably, the movable magnet actuator valve (100-1800) further comprises a bias spring (160) disposed between the magnet assembly (140) and the pole piece (150) that applies a spring force (Fs) to the magnet assembly (140).

Preferably, the coil assembly (1830) comprises two coils (1832a, 1832b) and a zero bias point (C0) of the magnet assembly (1840) is between the two coils (1832a, 1832b).

Preferably, the zero bias point (C0) of the magnet assembly (1840) is approximately equidistant between the two coils (1832a, 1832b).

Preferably, the movable magnet actuator valve (100-1800) further comprises a bobbin (170) disposed between the magnetic circuit (120) and the magnet assembly (140), wherein the bobbin (170) is adapted to hold the coil assembly (130).

Preferably, the magnet assembly (140-1840) comprises a magnet (142-1842) coupled to a seal (144-1844), wherein the magnet (142-1842) presses the seal (144-1844) against the first orifice (118-1818) or the second orifice (1618b).

According to another aspect, a method of controlling fluid through a movable magnet actuator valve comprises providing a first orifice that fluidly couples a first fluid port and a second fluid port on the movable magnet actuator valve, forming a current induced magnetic field that applies a current induced force to a magnet assembly to displace the magnet assembly away from the first orifice, and forming a pole force on the magnet assembly with a pole piece that retains the magnet assembly in a position displaced away from the first orifice.

Preferably, the method of controlling fluid through the movable magnet actuator valve further comprises pressing the magnet assembly against a second fluid orifice with the pole force.

Preferably, the method of controlling fluid through the movable magnet actuator valve further comprises reducing the current induced force to approximately zero when the magnet assembly is displaced away from the first orifice.

Preferably, the method of controlling fluid through the movable magnet actuator valve further comprises biasing the magnet assembly towards the first orifice with a spring force.

Preferably, the method of controlling fluid through the movable magnet actuator valve further comprises biasing the magnet assembly towards the first orifice with a reluctance force.

According to an aspect, a method of forming a movable magnet actuator valve (100-1800) comprises providing an orifice (118-1818) that fluidly couples a first fluid port (112-1812) and a second fluid port (114-1814) on the movable magnet actuator valve (100-1800), providing a magnet assembly (140-1840) that is movable relative to the orifice (118-1818) to selectively fluidly couple the first fluid port (112-1812) and the second fluid port (114-1814), and providing a pole piece (150-1850) adapted to apply a pole force to the magnet assembly (140-1840) and measuring the pole force while positioning the magnet assembly (140-1840).

Preferably, the method of forming the movable magnet actuator valve (100-1800) further comprises positioning the pole piece (150-1850) relative to the magnet assembly (140-1840) such that the pole force retains the magnet assembly (140-1840) in a position away from the orifice (118-1818) when a current induced force is not applied to the magnet assembly (118-1818).

Preferably, the method of forming the movable magnet actuator valve (100-1800) further comprises applying a bias force that presses the magnet assembly towards the orifice (118-1818).

Preferably, the bias force is comprised of a reluctance force of a magnetic circuit (120-1820) that surrounds the magnet assembly (140-1840).

Preferably, the bias force is comprised of a spring force applied to the magnet assembly (140) by a spring (160).

### BRIEF DESCRIPTION OF THE DRAWINGS

The same reference number represents the same element on all drawings. It should be understood that the drawings are not necessarily to scale.

FIG. 1 shows a perspective view of the movable magnet actuator valve 100 with a pole piece according to an embodiment.

FIG. 2 shows a cross-section side view of the movable magnet actuator valve 100 with the pole piece taken at section 2-2 shown in FIG. 1.

FIGS. 3 and 4 show block diagrams of the movable magnet actuator valve 100.

FIGS. 5 and 6 show another block diagram of the movable magnet actuator valve 100 according to an embodiment.

FIG. 7 is a graph 700 with two plots that compares the forces on the magnet assembly 140 due to the pole piece 150 and with forces on the magnet assembly when the pole piece 150 is not present.

FIG. 8 shows a block representation of a movable magnet actuator valve 800 with a pole piece 850 according to an embodiment.

FIG. 9 shows a block representation of a movable magnet actuator valve 900 with a pole piece 950 according to an embodiment.

FIG. 10 shows a block representation of a movable magnet actuator valve 1000 with a pole piece 1050 according to an embodiment.

FIG. 11 shows a block representation of a movable magnet actuator valve 1100 with a pole piece 1150 according to an embodiment.

FIG. 12 shows a block representation of a movable magnet actuator valve 1200 with a pole piece 1250 according to an embodiment.

FIG. 13 shows a block representation of a movable magnet actuator valve 1300 with a pole piece 1350 according to an embodiment.

FIG. 14 shows a block representation of a movable magnet actuator valve 1400 with a pole piece according to an embodiment.

FIG. 15 shows a block representation of a movable magnet actuator valve 1500 with a pole piece 1550 according to an embodiment.

FIGS. 16 and 17 show a block representation of a movable magnet actuator valve 1600 with a pole piece according to an embodiment.

FIG. 18 shows a schematic presentation of a movable magnet actuator valve 1800 with a pole piece according to an embodiment.

FIG. 19 shows a force versus displacement graph 1900 of a movable magnet actuator valve according to an embodiment.

### DETAILED DESCRIPTION

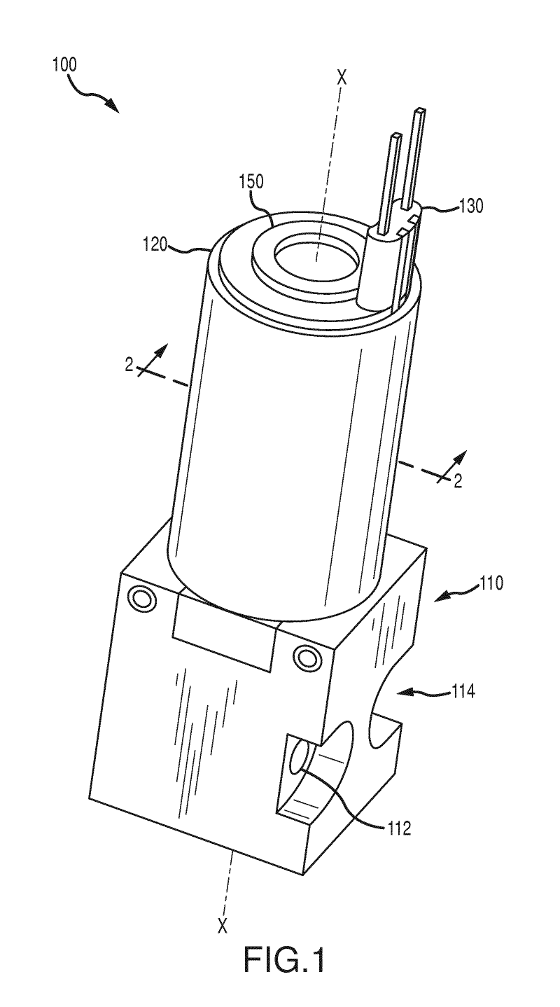

FIGS. 1-19 and the following description depict specific examples to teach those skilled in the art how to make and use the best mode of embodiments of a movable magnet actuator valve with a pole piece. For the purpose of teaching inventive principles, some conventional aspects have been simplified or omitted. Those skilled in the art will appreciate variations from these examples that fall within the scope of the present description. Those skilled in the art will appreciate that the features described below can be combined in various ways to form multiple variations of the movable magnet actuator valve with the pole piece. As a result, the embodiments described below are not limited to the specific examples described below, but only by the claims and their equivalents.

FIG. 1 shows a perspective view of the movable magnet actuator valve 100 with a pole piece according to an embodiment. The movable magnet actuator valve 100 is shown with a valve body 110. The valve body 110 includes a first fluid port 112 and a second fluid port 114. The valve body 110 is coupled to a magnetic circuit 120. A coil assembly 130 is disposed inside the magnetic circuit 120. The coil assembly 130 is shown as approximately centered in the magnetic circuit 120. Also shown is a pole piece 150 that is coupled to the coil assembly 130 proximate a second distal end of the magnetic circuit 120. The movable magnet actuator valve 100 is shown as having an axis X-X. In the embodiment of FIG. 1, the axis X-X extends through axial center of a longitudinal length of the movable magnet actuator valve 100.

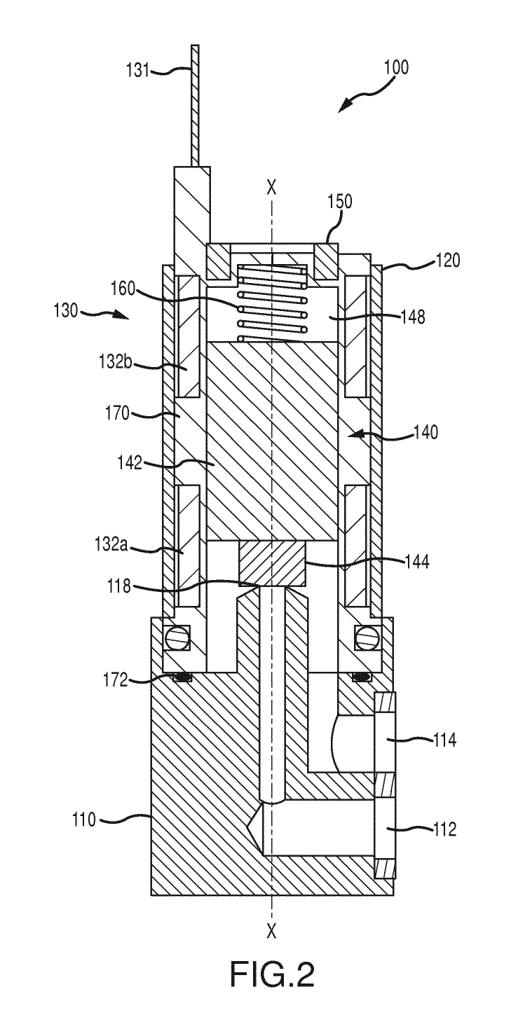

FIG. 2 shows a cross-section side view of the movable magnet actuator valve 100 with the pole piece taken at section 2-2 shown in FIG. 1. As shown in FIG. 2, the movable magnet actuator valve 100 includes the valve body 110 comprised of the first fluid port 112 and the second fluid port 114. In the embodiment shown, a coil assembly 130 is disposed in a magnetic circuit 120. The magnetic circuit 120 is coupled to the valve body 110 at a first distal end of the magnetic circuit 120. A magnet assembly 140 is disposed in the coil assembly 130. A bias spring 160 is disposed between the magnet assembly 140 and the pole piece 150 proximate a second distal end of the magnetic circuit 120. A bobbin 170 is disposed between the magnetic circuit 120 and the magnet assembly 140.

The magnetic circuit 120, the coil assembly 130, and the magnet assembly 140 are shown with cylindrical shapes disposed concentrically about an axis X-X of the movable magnet actuator valve 100. The magnetic circuit 120 is shown as substantially surrounding the coil assembly 130, the magnet assembly 140, and the bobbin 170. The coil assembly 130 is also shown as geometrically centered in the magnetic circuit 120. However, in alternative embodiments, the magnetic circuit 120 may not substantially surround the coil assembly 130 or the magnet assembly 140. Also, different shapes (e.g., rectangular) or arrangements may be employed. For example, the coil assembly 130 can be offset in the magnetic circuit 120. Additionally or alternatively, the bobbin 170 may not be employed. The magnetic circuit 120 and the bobbin 170 can be coupled to the valve body 110 in a variety of ways such as a weld or a press fit. The coil assembly 130 can be coupled to the magnetic circuit 120 or the bobbin 170 with adhesives or any other suitable means.

The valve body 110 can be comprised of a non-magnetic material such as brass. The first fluid port 112 in the valve body 110 can be coupled to a fluid source, such as compressed air or the like. The second fluid port 114 can be fluidly coupled to equipment that uses the fluid. The first fluid port 112 and the second fluid port 114 can be threaded openings although any suitable fluid connecting means may be employed. The orifice 118 can be an opening that is sized to regulate the flow rate of the fluid. Although a constant sized orifice 118 is shown, any suitable orifice and/or dimensions may be employed. For example, in alternative embodiments, a variable flow rate orifice may be employed.

The magnetic circuit 120 is comprised of a magnetic material with low reluctance. The magnetic material can be what is known in the art as “soft” magnetic material. An external magnetic field, such as a field generated by the magnet assembly 140, can induce an auxiliary magnetic field in the magnetic circuit 120. The magnetic field from the magnet assembly 140 is also concentrated into the magnetic circuit 120 due to the relatively low reluctance of the magnetic material when compared to, for example, the valve body 110 or the coil assembly 130.

The coil assembly 130 is adapted to carry a current that forms a current induced magnetic field. The current can be received by coil leads 131 which are be coupled to coils in the coil assembly 130. The coil assembly 130 can be comprised of two coils: a first coil 132a that is proximate the orifice 118 and a second coil 132b that is proximate the pole piece 150. Although two coils 132a,b are shown, the coil assembly 130 can be comprised of a single or a plurality of coils in alternative embodiments. The two coils 132a and 132b are shown as held by the bobbin 170 in a concentric arrangement that surrounds the magnet assembly 140.

The magnet assembly 140 is adapted to move linearly in the coil assembly 130. As will be explained in more detail in the following, the magnet assembly 140 is pressed against the orifice 118 by a bias force Fb that can be comprised of a reluctance force Fr when the coil assembly 130 is not carrying the current. The magnet assembly 140 is shown in FIG. 2 as including a magnet 142 coupled to a seal 144. The seal 144 is pressed against the orifice 118. In alternative embodiments, the seal 144 may not be present. For example, in alternative embodiments, the magnet assembly 140 can be comprised of the magnet 142 which can function as a seal. Additionally or alternatively, the magnet assembly 140 can be comprised of a plurality of magnets 142. For example, a plurality of magnets could be concentrically arranged in an annular ring with magnetic poles oriented in the same direction. Between the magnet assembly 140 and the bobbin 170 is an actuating space 148 in which the magnet assembly 140 can move as will be described in more detail in the following.

The pole piece 150 can be comprised of magnetic material that is adapted to form an auxiliary magnetic field. The pole piece 150 can form the auxiliary magnetic field from the current induced magnetic field formed by the coil assembly 130. The pole piece 150 is shown as having a toroidal shape that is partially embedded into the bobbin 170. In alternative embodiments, the pole piece 150 can have alternative shapes. For example, an alternative pole piece could have a flat disk shape. Additionally or alternatively, the pole piece 150 could be coupled to the magnet assembly 140 as well as the bias spring 160.

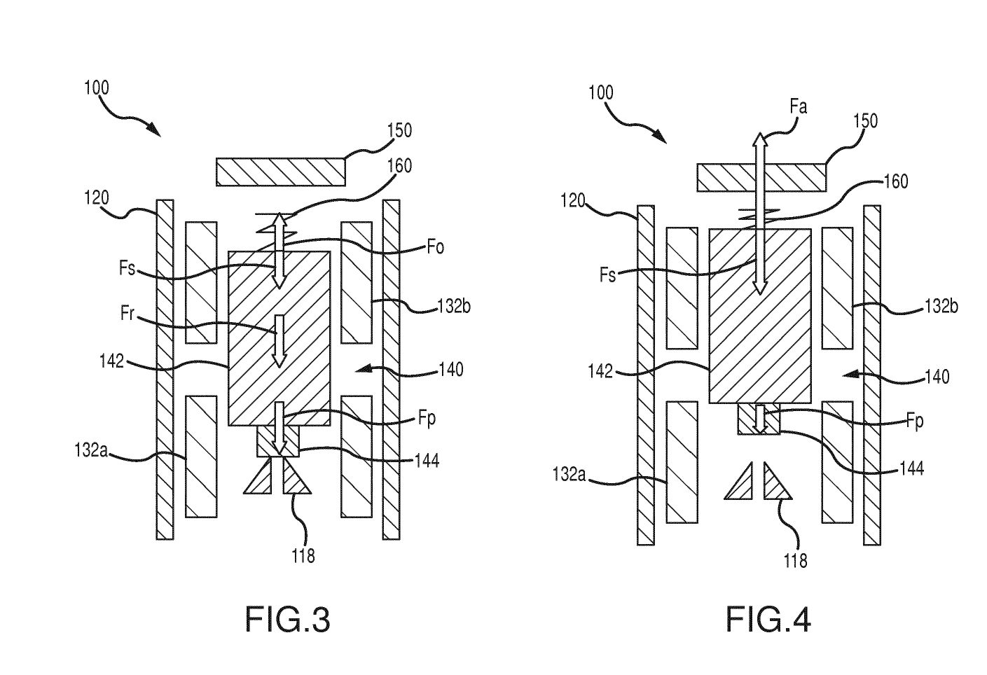

The bias spring 160 can apply a spring force Fs to the magnet assembly 140. The spring force Fs can be oriented towards the orifice 118 although the spring force Fs can be oriented in other directions in alternative embodiments. The bias spring 160 is shown as a coil spring that is coaxial with the axis X-X. The bias spring 160 is also shown as pressed against the magnet assembly 140 and the bobbin 170. In the closed position shown in FIG. 2, the bias spring 160 is pressing the magnet assembly 140 into the orifice 118. The spring force Fs and other forces acting on the magnet assembly 140 are described in more detail with reference to FIGS. 3 and 4.

Still referring to FIG. 2, the bobbin 170 is adapted to hold the coil assembly 130 and is comprised of a non-magnetic material such as brass or a plastic. An O-ring 172 is disposed between the valve body 110 and the bobbin 170. The O-ring 172 prevents fluid from leaking from the movable magnet actuator valve 100. In alternative embodiments, the O-ring 172 may not be employed. In such embodiments, the bobbin 170 can be attached to the valve body 110 to provide the fluid seal. For example, a weld or a press fit between the bobbin 170 and the valve body 110 can prevent fluid from flowing through the movable magnet actuator valve 100.

The foregoing describes the features of the movable magnet actuator valve 100 with the pole piece 150. The following describes the forces on the magnet assembly 140 as well as magnet assemblies in alternative embodiments of the movable magnet actuator valve. To aid in the understanding of the forces on the magnet assemblies, the embodiments are represented as block diagrams in the figures.

FIGS. 3 and 4 show block diagrams of the movable magnet actuator valve 100. The block diagrams illustrate the forces that are applied to the magnet assembly 140 according to an embodiment. In the embodiment shown, the movable magnet actuator valve 100 includes the magnetic circuit 120, which is disposed around the coil assembly 130 and the magnet assembly 140. A block representation of the valve body 110 is not shown for clarity. The spring 160 is disposed between the magnet assembly 140 and the pole piece 150. Also shown are the two coils 132a, 132b. The magnet assembly 140 is shown with the magnet 142 and the seal 144.

In FIG. 3, the magnet assembly 140 is pressed against the orifice 118 in a closed position. The magnet assembly 140 may be pressed against the orifice 118 due to the spring force Fs that is oriented towards the orifice 118. Also oriented towards the orifice 118 are the fluid pressure Fp and the reluctance force Fr. The spring force Fs, fluid pressure Fp, and reluctance force Fr press the magnet assembly 140 into the orifice 118. The magnet assembly 140 being pressed into the orifice 118 can prevent the fluid from flow through the orifice 118.

In FIG. 4, the magnet assembly 140 is displaced away from the orifice 118 by an actuation force Fa to an open position. The actuation force Fa is oriented towards the pole piece 150 although the actuation force Fa may be oriented in different directions in alternative embodiments. The actuation force Fa can be comprised of the pole force Fo and the current induced magnetic field applying a force on the magnet 142. Accordingly, the actuation force Fa shown in FIG. 4 can correspond to an initial current value in the coil assembly 130. Fluid can flow through the orifice 118 when the magnet assembly 140 is in the open position.

Due to the movement from the closed position shown in FIG. 3 to the open position shown in FIG. 4, the bias spring 160 is compressed. When the bias spring 160 is compressed, the spring force Fs increases, which is illustrated by the increased arrow size from FIG. 3 to FIG. 4. As can also be appreciated, the fluid pressure Fp decreases when the magnet assembly 140 moves from the closed position to the open position. The fluid pressure Fp can decrease due to, for example, the reduction in a differential fluid pressure between the first fluid port 112 and second fluid port 114 due to the fluid pressure flowing through the orifice 118.

Although not shown in FIGS. 3 and 4, the pole force Fo increases as the magnet assembly 140 moves from the closed position to the open position, which can be relied on to hold the magnet assembly 140 in the open position shown in FIG. 4, as will be described in more detail in the following.

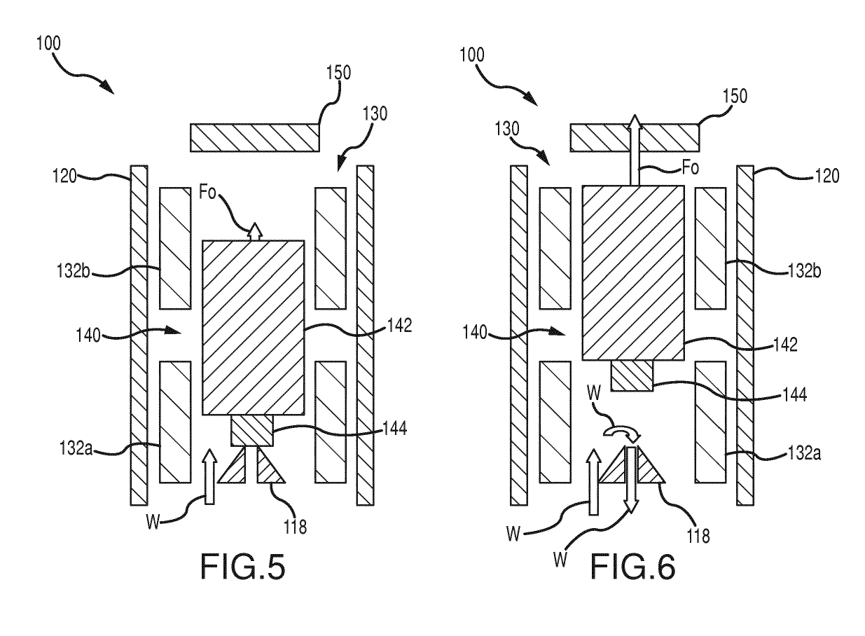

FIGS. 5 and 6 show another block diagram of the movable magnet actuator valve 100 according to an embodiment. The movable magnet actuator valve 100 is shown without the spring 160 and the actuation force Fa so that the pole force Fo can be shown. In FIG. 5, the magnet assembly 140 is in the closed position. In FIG. 6, the magnet assembly 140 is moved towards the pole piece 150 due to the actuation force Fa described with reference to FIGS. 3 and 4. As can be seen in FIG. 6, the magnitude of the pole force Fo increases as the magnet assembly 140 gets closer to the pole piece 150. This is due to the reduced distance between the magnet assembly 140 and the pole piece 150.

It can be appreciated that the increase in the pole force Fo can be sufficient to prevent the magnet assembly 140 from moving to reduce or eliminate the current in the coil assembly 130. For example, the current through the coil assembly 130 when the magnet assembly 140 is in the closed position can be at an actuation current value to move the magnet assembly 140 away from the orifice 118. When the magnet assembly 140 reaches the open position shown in FIG. 6, the current through the coil assembly 130 can be reduced to a hold current value that is less than the initial current value. In some embodiments, the hold current value may be approximately zero. At the hold current value, the magnet assembly 140 may be stationary. Accordingly, the magnet assembly 140 may remain in the open position shown in FIG. 6.

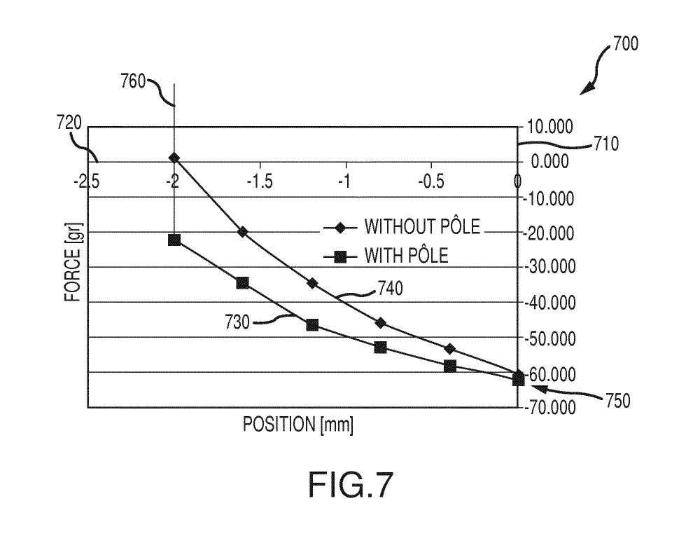

The displacement of the magnet assembly 140 between the open and closed positions shown in FIGS. 5 and 6 as well as a comparison between the forces on the magnet assembly 140 with and without the pole piece 150 are described in more detail in the following with reference to FIG. 7.

FIG. 7 is a graph 700 with two plots that compare the forces on the magnet assembly 140 due to the pole piece 150 and with forces on the magnet assembly 140 when the pole piece 150 is not present. The graph 700 includes a force axis 710 that shows the magnitude of the forces on the magnet assembly 140 in a direction that is parallel to the axis X-X. The magnitude of the forces range from −70 to 10 grams-force (denoted as “gr”). The negative values indicate that the force is directed away from the orifice 118. The positive values indicate that the force is directed towards the orifice 118. The graph 700 also includes a position axis 720 that shows the position of the magnet assembly 140 relative to the orifice 118. The position axis 720 ranges from 0 to −2.5 mm. The negative values on the position axis 720 indicates the distance that the magnet assembly 140 is displaced away from the orifice 118. The graph 700 includes a pole plot 730 and a non-pole plot 740. Also shown in the graph 700 are closed position data points 750 and open position data points 760. The plots 730, 740 are exemplary and can be different in alternative embodiments.

With reference to the embodiment shown in FIG. 7, at the position 0 on the position axis 720, which corresponds to the closed position shown in FIGS. 3 and 5, the forces on the magnet assembly 140 are approximately −60 grams-force for both the movable magnet actuator valve 100 with the pole piece 150 and the valve without a pole piece. As discussed in the foregoing, the negative value of the forces indicates that the net forces acting on the magnet assembly 140 is directed away from the orifice 118. Accordingly, the magnet assembly 140 will move away from the orifice 118.

As the magnet assembly 140 is displaced away from the orifice 118, the distance between the magnet assembly 140 and the orifice 118 increases. Both the pole plot 730 and the non-pole plot 740 trend towards the position axis 720 as the distance increases. However, the pole plot 730 does not trend towards the position axis 720 as fast as the non-pole plot 740.

At position −2 on the position axis 720 axis, which corresponds to the fully open position shown in FIGS. 4 and 6, the forces on the magnet assembly 140 are approximately −22 gr. Without the pole piece 150, the forces on the magnet assembly 140 are zero. In the movable magnet actuator valve 100, the magnet assembly 140 may not continue moving away from the orifice 118 due to, for example, reaching the bobbin 170. In addition, the −22 gr force on the magnet assembly 140 can be predominately comprised of the pole force Fo induced by the pole piece 150. Accordingly, the magnet assembly 140 may remain in the fully open position shown in FIGS. 4 and 6.

Although the foregoing describes the current as being reduced when the magnet assembly 140 reaches the open position, any appropriate current values can be employed at any magnet assembly 140 positions. For example, the current can be reduced from the actuation current to the hold current value while the magnet assembly 140 is moving. The current values at the various positions of the magnet assembly 140 can also be selected with, for example, a spring constant k and other properties of the spring 160.

Other parameters and properties can also be employed to select the current values. For example, alternative pole pieces can have different shapes, sizes, and positions. Additionally or alternatively, alternative magnetic circuits may have different shapes, be coupled to the pole pieces, and may not be part of the alternative movable magnet actuator valves. The following FIGS. 8-13 illustrate alternative embodiments with different properties and parameters.

FIG. 8 shows a block representation of a movable magnet actuator valve 800 with a pole piece 850 according to an embodiment. The movable magnet actuator valve 800 includes a first fluid port 812 and a second fluid port 814. As shown in FIG. 8, a magnet assembly 840 is disposed in a coil assembly 830. The coil assembly 830 is comprised of a first coil 832a and a second coil 832b. The magnet assembly 840 includes a magnet 842 and a seal 844 that is pressed against an orifice 818. In contrast to the movable magnet actuator valve 100 described in the foregoing, the movable magnet actuator valve 800 does not include the magnetic circuit 120. The magnet assembly 840 is held in the closed position by a spring 860. The spring constant of the spring 860 can be selected to ensure that the magnet assembly 840 remains pressed against the orifice 818.

FIG. 9 shows a block representation of a movable magnet actuator valve 900 with a pole piece 950 according to an embodiment. The movable magnet actuator valve 900 includes a first fluid port 912 and a second fluid port 914. As shown in FIG. 9, a magnet assembly 940 is disposed in a coil assembly 930. The coil assembly 930 is comprised of a first coil 932a and a second coil 932b. The magnet assembly 940 includes a magnet 942 and a seal 944 that is pressed against an orifice 918. In contrast to the movable magnet actuator valve 100 described in the foregoing, the magnetic circuit 920 and the pole piece 950 are a single piece. Additionally, the pole piece 950 is shown as being thicker and having an opening.

FIG. 10 shows a block representation of a movable magnet actuator valve 1000 with a pole piece 1050 according to an embodiment. The movable magnet actuator valve 1000 includes a first fluid port 1012 and a second fluid port 1014. As shown in FIG. 10, a magnet assembly 1040 is disposed in a coil assembly 1030. The coil assembly 1030 is comprised of a first coil 1032a and a second coil 1032b. The magnet assembly 1040 includes a magnet 1042 and a seal 1044 that is pressed against an orifice 1018. In contrast to the movable magnet actuator valve 100 described in the foregoing, the pole piece 1050 is formed integrally with the magnetic circuit 1020. In addition, the pole piece 1050 does not have an opening and is about the thickness of the pole piece 150 described with reference to FIGS. 2-6.

FIG. 11 shows a block representation of a movable magnet actuator valve 1100 with a pole piece 1150 according to an embodiment. The movable magnet actuator valve 1100 includes a first fluid port 1112 and a second fluid port 1114. As shown in FIG. 11, a magnet assembly 1140 is disposed in a coil assembly 1130. The coil assembly 1130 is comprised of a first coil 1132a and a second coil 1132b. The magnet assembly 1140 includes a magnet 1142 and a seal 1144 that is positioned away from an orifice 1118 in an open position. The pole piece 1150 is shown as being displaced away from the pole piece position 1150′. The pole piece position 1150′ can correspond to the position of the pole piece 150 shown in FIGS. 2-6. Accordingly, the pole force Fo on the magnet assembly 1140 can be less than the pole force Fo on the magnet assembly 140 at the same relative distance from their respective magnet assembly 140, 1140. The position of the pole piece 1150 can be selected to provide a desirable amount of pole force Fo when the magnet assembly 1140 is at a given position from the orifice 1118.

The positions of the pole piece 1150 can be set through various means. For example, the pole piece 1150 could be threadedly coupled to the coil assembly 1130 via a bobbin (not shown). Accordingly, turning the pole piece 1150 can move the pole piece 1150 to a desired position. In some embodiments, the position of the pole piece 1150 could be determined during testing of the movable magnet actuator valve 1100 so the desired pole force Fo or other variable, such as fluid pressure or current draw, is obtained. For example, it may be desirable to have zero hold current provided to the coil assembly 130 when the magnet assembly 1140 is in the fully open position. Positioning the pole piece 1150 may provide sufficient pole force Fo to allow for the zero hold current. The positions of the pole piece 1150 can also be determined during design, fabrication, or other times, such as after being installed on equipment.

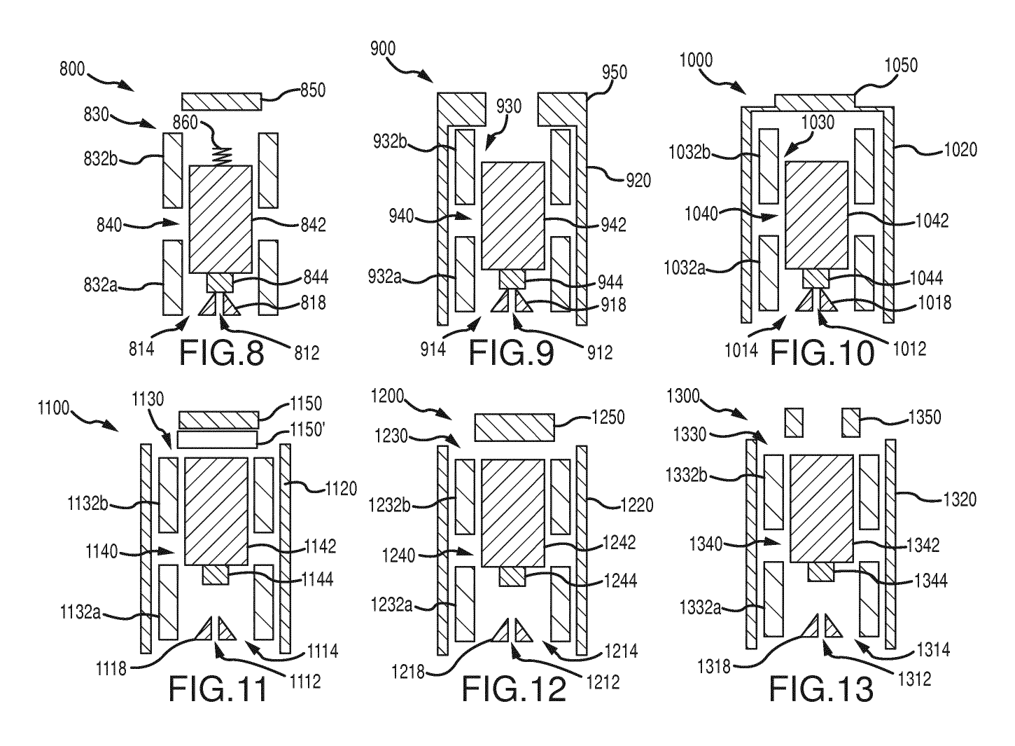

FIG. 12 shows a block representation of a movable magnet actuator valve 1200 with a pole piece 1250 according to an embodiment. The movable magnet actuator valve 1200 includes a first fluid port 1212 and a second fluid port 1214. As shown in FIG. 12, a magnet assembly 1240 is disposed in a coil assembly 1230. The coil assembly 1230 is comprised of a first coil 1232a and a second coil 1232b. The magnet assembly 1240 includes a magnet 1242 and a seal 1244 that is disposed away from an orifice 1218 in an open position. The pole piece 1250 is shown as being larger than the pole piece 150 shown in FIGS. 2-6. Accordingly, the pole force Fo on the magnet assembly 1240 can be greater than the pole force Fo on the magnet assembly 140 at the same relative distance from their respective magnet assembly 140, 1240. The thickness of the pole piece 1250 can be selected to provide a desirable amount of pole force Fo when the magnet assembly 1240 is at the relative distance from the pole piece 1250.

FIG. 13 shows a block representation of a movable magnet actuator valve 1300 with a pole piece 1350 according to an embodiment. The movable magnet actuator valve 1300 includes a first fluid port 1312 and a second fluid port 1314. As shown in FIG. 13, a magnet assembly 1340 is disposed in a coil assembly 1330. The coil assembly 1330 is comprised of a first coil 1332a and a second coil 1332b. The magnet assembly 1340 includes a magnet 1342 and a seal 1344 that is disposed away from an orifice 1318 in an open position. The pole piece 1350 is shown as being thicker than the pole piece 150 described with reference to FIGS. 2-6, but with an opening and having less mass. Accordingly, the pole force Fo on the magnet assembly 1340 can be less than the pole force Fo on the magnet assembly 140 at the same relative distance from their respective magnet assembly 140, 1340. The thickness and size of the opening in the pole piece 1350 can be selected to provide a desirable amount of pole force Fo when the magnet assembly 1340 for a given distance from the pole piece 1350.

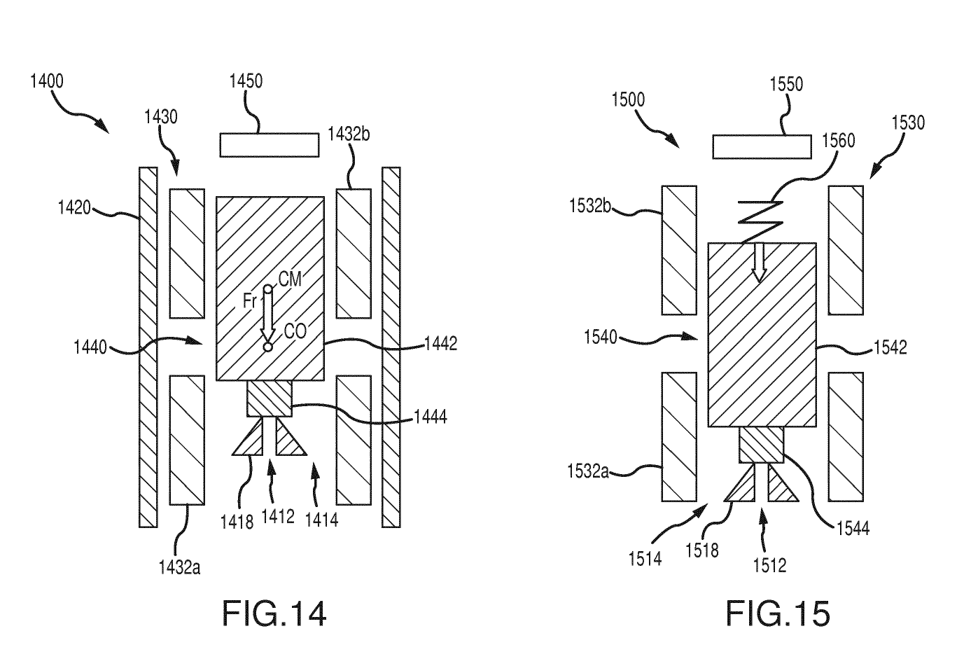

The position, size, and form of the pole piece 850-1250 can be varied along with other parameters, such as the center offset of the magnet assembly 840-1240 or the spring constant of the spring 160. These parameters are described in more detail in the following with respect to FIGS. 14 and 15.

FIG. 14 shows a block representation of a movable magnet actuator valve 1400 with a pole piece according to an embodiment. The movable magnet actuator valve 1400 includes a first fluid port 1412 and a second fluid port 1414. As shown in FIG. 14, a magnet assembly 1440 is disposed in a coil assembly 1430. The coil assembly 1430 is comprised of a first coil 1432a and a second coil 1432b. The magnet assembly 1440 includes a magnet 1442 and a seal 1444 that is pressed against an orifice 1418. The pole piece 1450 is disposed over the magnet assembly 1440. The movable magnet actuator valve 1400 employs a magnetic circuit 1420 that provides a reluctance force Fr that presses the magnet assembly 1440 into the orifice 1418. More specifically, the magnet assembly 1440 is offset from the center of the magnetic circuit 1420, as described in more detail in the following.

The magnetic field from the magnet assembly 1440 concentrates in the magnetic circuit 1420 and induces the auxiliary magnetic field. This is due to the relatively low magnetic reluctance of the magnetic circuit 1420. The auxiliary magnetic field and the concentration of the magnetic field form the reluctance force Fr on the magnet assembly 1440. The magnitude of the reluctance force Fr can be inversely proportional to the magnetic reluctance of the magnetic circuit 1420 and the strength of the magnetic field from the magnet assembly 1440. For example, for a given CM-C0 offset, the lower the magnetic reluctance of the magnetic circuit 1420, the greater the magnitude of the reluctance force Fr.

The reluctance Fr force tends to minimize a distance between the magnet center CM and the zero bias point C0. In other words, the reluctance force Fr is a force vector directed from the magnet center CM to the zero bias point C0. Accordingly, when the magnet assembly 1440 is, for example, offset from the orifice 1418, the reluctance force Fr presses the magnet assembly 1440 towards the zero bias point C0. This causes the magnet assembly 1440 to press into the orifice 1418. Since the movable magnet actuator valve 1400 does not include the bias spring, the bias force Fb is proportional or equal to the reluctance force Fr. Accordingly, a spring may not necessarily be employed in the movable magnet actuator valve 1400.

FIG. 15 shows a block representation of a movable magnet actuator valve 1500 with a pole piece 1550 according to an embodiment. The movable magnet actuator valve 1500 includes a first fluid port 1512 and a second fluid port 1514. As shown in FIG. 15, a magnet assembly 1540 is disposed in a coil assembly 1530. The coil assembly 1530 is comprised of a first coil 1532a and a second coil 1532b. The magnet assembly 1540 includes a magnet 1542 and a seal 1544 that is pressed against an orifice 1518. The pole piece 1550 is disposed over the magnet assembly 1540. The movable magnet actuator valve 1500 employs a spring 1560 that presses the magnet assembly 1540 into the orifice 1518. Although not shown, the spring 1560 can also press against a valve body to provide a spring force Fs. The spring force Fs is shown as an arrow in the magnet 1542 directed towards the orifice 1518. Accordingly, a magnetic circuit may not be employed.

The foregoing embodiments describe various embodiments of a two-port valve. Other embodiments, such as those described in the following, can be comprised of three or more ports.

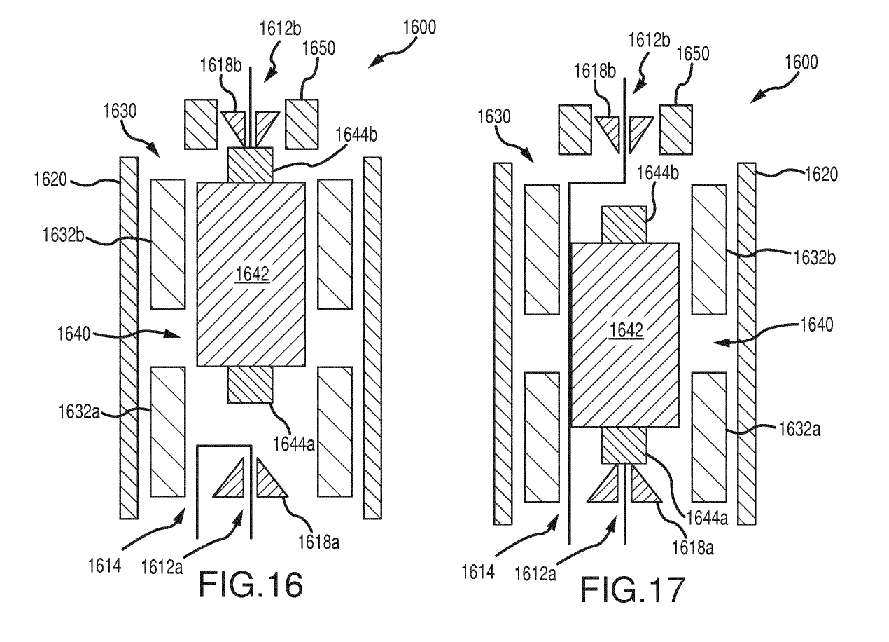

FIGS. 16 and 17 show a block representation of a movable magnet actuator valve 1600 with a pole piece according to an embodiment. The movable magnet actuator valve 1600 includes a part of first fluid ports 1612a, 1612b and a second fluid port 1614. As shown in FIG. 16, a magnet assembly 1640 is disposed in a coil assembly 1630. The coil assembly 1630 is comprised of a first coil 1632a and a second coil 1632b. The magnet assembly 1640 includes a magnet 1642. The magnet assembly 1640 also includes a first seal 1644a and a second seal 1644b that can be pressed against a first orifice 1618a and a second orifice 1618b, respectively. The pole piece 1650 is disposed over the magnet assembly 1640. The movable magnet actuator valve 1600 employs a magnetic circuit 1620 that provides a reluctance force that biases the magnet assembly 1640 towards the center of the magnetic circuit 1620.

In the position shown in FIG. 16, the magnet assembly 1640 is pressed against the second orifice 1618b. In particular, the second seal 1644b on the magnet assembly 1640 is pressed against the second orifice 1618b. The first seal 1644a is displaced away from the first orifice 1618a. The magnet assembly 1640 can be pressed against the second orifice 1618b due to current in the coil assembly 1630 that applies a current induced force to the magnet assembly 1640 and a pole force that are directed towards the second orifice 1618b. As can also be appreciated from FIG. 16, the magnet assembly 1640 is offset in the magnetic circuit 1620. Accordingly, the magnet assembly 1640 experiences a reluctance force that biases the magnet assembly 1640 towards the center of the magnetic circuit 1620.

The current induced force and the pole force can be sufficient to overcome the reluctance force as well as any differential fluid pressures in the movable magnet actuator valve 1600. Similar to the embodiments described with reference to FIGS. 1-6 and 8-14, the pole piece 1650 can be sized and positioned to minimize the current required to hold the magnet assembly 1640 in the position shown in FIG. 16. Accordingly, minimal to zero holding current is required to maintain the magnet assembly 1640 in the position shown in FIG. 16.

In the position shown in FIG. 17, the magnet assembly 1640 is pressed against the first orifice 1618a. In particular, the first seal 1644a on the magnet assembly 1640 is pressed against the first orifice 1618a. The second seal 1644b is displaced away from the second orifice 1618b. As discussed in the foregoing with reference to FIGS. 1-15, the pole force on the magnet assembly 1640 decreases the further the magnet assembly 1640 is displaced away from the pole piece 1650. Accordingly, in the position shown in FIG. 17, the reluctance force may be sufficient to overcome the pole force and as well as any other forces, such as the fluid pressures on the magnet assembly 1640 or the like.

The embodiments described in the foregoing with reference to FIGS. 1-17, as well as other embodiments, can be formed by a variety of methods such as press fitting, ultrasonic welding, or the like. The following shows an exemplary embodiment where portions of a bobbin are ultrasonically welded simultaneous to measuring parameters in the magnet assembly to ensure that the forces acting on the magnet assembly are at the desired amount.

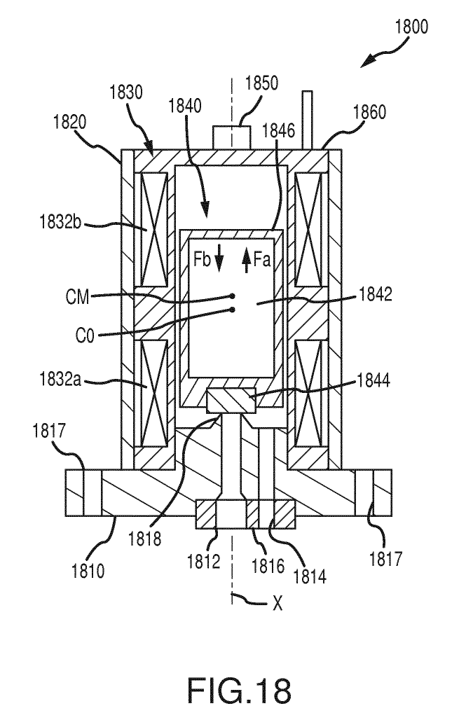

FIG. 18 shows a schematic representation of a movable magnet actuator valve 1800 with a pole piece according to an embodiment. As shown, the movable magnet actuator valve 1800 with a pole piece includes a valve body 1810 comprised of a first fluid port 1812 and a second fluid port 1814. The valve body 1810 can also include an interface 1816 and connector openings 1817. A magnetic circuit 1820 is coupled to the valve body 1810 and a coil assembly 1830 is disposed in the magnetic circuit 1820. A magnet assembly 1840 is disposed in the coil assembly 1830. A pole piece 1850 is disposed proximate the coil assembly 1830. A bobbin 1860 is disposed between the magnetic circuit 1820 and the magnet assembly 1840.

The magnetic circuit 1820, the coil assembly 1830, magnet assembly 1840, pole piece 1850, and bobbin 1860 are shown with cylindrical shapes arranged concentrically about an axis X of the movable magnet actuator valve 1800. The magnetic circuit 1820 is shown as substantially surrounding the coil assembly 1830, magnet assembly 1840, and bobbin 1860. The coil assembly 1830 is also shown as geometrically centered in the magnetic circuit 1820. However, in alternative embodiments, the magnetic circuit 1820 may not substantially surround the coil assembly 1830 or the magnet assembly 1840. Also, different shapes (e.g., rectangular) or arrangements may be employed. For example, the coil assembly 1830 can be offset in the magnetic circuit 1820. Additionally or alternatively, the bobbin 1860 may not be employed. The magnetic circuit 1820 and the bobbin 1860 can be coupled to the valve body 1810 in a variety of ways such as a weld or a press fit. The coil assembly 1830 can be coupled to the magnetic circuit 1820 or the bobbin 1860 with adhesives or any other suitable means.

Also shown in FIG. 18 are a zero bias point C0 of the magnetic circuit 1820 and a magnet center CM of the magnet assembly 1840. The magnet center CM is the geometric center of the magnet 1842. The zero bias point C0 is the location of the magnet center CM when the reluctance force is zero. The zero bias point C0 is usually about the geometric center of the magnetic circuit 1820. As shown in FIG. 18, the zero bias point C0 is at or near the geometric center of the coil assembly 1830. That is, the zero bias point C0 is shown as equidistant between the two coils 1832a,1832b. The magnet center CM is also shown as offset from the zero bias point C0. The offset can be determined by the length of the magnet 1842, the seal 1844, and a thickness of an encapsulation 1846 around the magnet 1842.

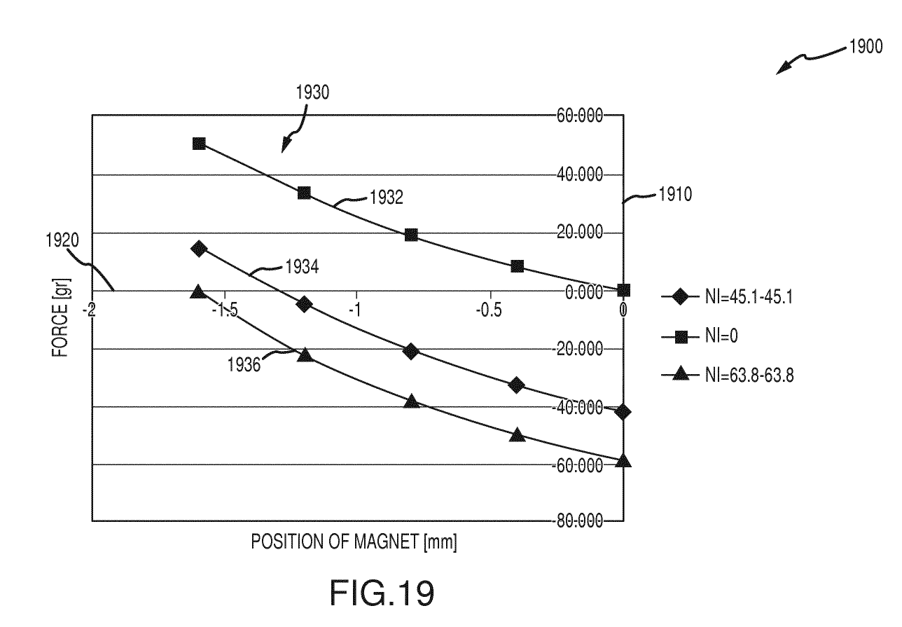

FIG. 19 shows a force versus displacement graph 1900 of a movable magnet actuator valve according to an embodiment. The force versus displacement graph 1900 has a force axis 1910 shown as a vertical line with units of gram-force (denoted as “[gr]”). The force axis 1910 has vertically spaced lines labeled with numerals ranging from −80.000 to 60.000 which correspond to −80 gram-force to 60 gram-force. The force versus displacement graph 1900 also has a position axis 1920 shown as a horizontal line with units of millimeter (denoted as “[mm]”) intersecting the force axis 1910. The position axis 1920 has tic marks with numerals ranging from 0 to −2 which correspond to 0 mm and −2 mm. There are three curves 1930 shown in the force versus displacement graph 1900: a bias force curve 1932, a low-turn-count curve 1934, and a high-turn-count curve 1936.

The force versus displacement graph 1900 can correspond to an embodiment of the movable magnet actuator valve 1800 where the coil assembly 1830 is centered in the magnetic circuit 1820. The coil assembly 1830 has two coils 1832a, 1832b that are connected in series. The two coils 1832a, 1832b have an equal number of opposing turns in their respective windings.

The numerals in the position axis 1920 are measured distances of the magnet center CM from the zero bias point C0 (the CM-C0 offset). The force axis 1910 represents a measured force on the magnet assembly 1840. A positive numeral in the force axis 1910 represents a measured force that points to the zero bias point C0. A negative numeral represents a measured force that is points away from the zero bias point C0, which can be towards the pole 1850. The measured force is approximately equal to the bias force Fb when there is no current in the coil assembly 1830. When there is current in the coil assembly 1830, the measured force is approximately equal to the bias force Fb plus the actuation force Fa.

The bias force curve 1932 shows the measured force on the magnet assembly 1840 when there is no current in the coil assembly 1830. The bias force curve 1932 therefore represents the bias force Fb comprised of the reluctance force from the magnetic circuit 1820. As can be seen, the bias force Fb is zero when the CM-C0 offset is zero. The bias force Fb increases as the CM-C0 offset increases (e.g., the magnet assembly 1840 moves away from the orifice 1818). The bias force curve 1932 therefore shows that the bias force Fb is always directed towards the zero bias point C0. As a result, the magnet assembly 1840 will tend to move towards the orifice 1818 when there is no current in the coil assembly 1830. The bias force curve 1932 also shows that the relationship between bias force Fb and the CM-C0 offset is substantially linear.

The low turn-count curve 1934 shows the measured force on the magnet assembly 1840 when there is current in two coils 1832a and 1832b with respective 45.1 and −45.1 turns in their windings. The low turn-count curve 1934 therefore represents the bias force Fb and the actuation force Fa on the magnet assembly 1840 (“low turn-count force”). The low turn-count curve 1934 shows that the low turn-count force is directed away from the zero bias point C0 when the CM-C0 offset is zero. This will cause the magnet assembly 1840 to move away from the zero bias point C0. The low turn-count curve 1934 also shows that the magnitude of the low turn-count force decreases to zero when the CM-C0 offset is about −1.3 mm. Where the low turn-count force is zero is about where the actuation force Fa is equal to the bias force Fb. Further increasing CM-C0 offset points the low turn-count force to the zero bias point C0. The magnet assembly 1840 will therefore tend to stop moving at or near where the low turn-count curve 1934 intersects the “0” force line. The low turn-count curve 1934 also shows that the relationship between the low turn-count force and the CM-C0 offset is substantially linear.

The high turn-count curve 1936 shows the measured force on the magnet assembly 1840 when there is current in two coils 1832a and 1832b with respective 63.8 and −63.8 turns in their windings. The high turn-count curve 1936 therefore represents the bias force Fb and the actuation force Fa on the magnet assembly 1840 (“high turn-count force”). The high turn-count curve 1936 shows that the high turn-count force is directed away from the zero bias point C0 when the CM-C0 offset is zero. This will cause the magnet assembly 1840 to move away from the zero bias point C0. The high turn-count curve 1936 also shows that the magnitude of the high turn-count force decreases to zero when the CM-C0 offset is about −1.6 mm. Where the high turn-count force is zero is about where the actuation force Fa is equal to the bias force Fb. Further increasing CM-C0 offset points the high turn-count force to the zero bias point C0. The magnet assembly 1840 will therefore tend to stop moving at or near where the high turn-count curve 1936 intersects the “0” force line. The bias force curve 1932 also shows that the relationship between high turn-count force and the CM-C0 offset is substantially linear.

Referring now to the embodiments described in the foregoing with reference to FIGS. 1-18, the bias force Fb can be determined by selecting various parameters. For example, in embodiments that include a magnetic circuit, the bias force Fb can include a reluctance force from the zero offset of the magnet assembly. In embodiments with a spring 160, the bias force Fb can include the spring force Fs. The bias force Fb can also include fluid pressures Fp due to the pressure differential between the fluid ports 112, 114 to 1812, 1814. The bias force Fb, for example, can be directed away from the pole 150-1850 and towards the orifice 118-1818.

The actuation force Fa can include the pole force Fo and the current induced force. If the pole force Fo and the current induced force are greater than the bias force Fb, then the sum of the actuation force Fa and the bias force Fb can be directed towards the pole 150-1550. For example, in the embodiments with two ports, the actuation force Fa can be directed away from the orifice 118-1818. Accordingly, the magnet assembly 140-1740 can move away from the orifice 118-1818. As discussed in the foregoing, the pole force Fo at the position closest to the pole piece 150-1850 is greater than zero. The current in the coil assembly 130-1830 can therefore be reduced to zero.

The pole piece 150-1850 can be sized and positioned such that the pole force Fo is sufficient to minimize or zero the current in the coil assembly 130-1830. For example, the pole piece 1150 described with reference to FIG. 11 can be positioned by, for example, turning the pole piece 1150, which may be threaded. The position of the pole piece 1150 can be set while the current and other parameters, such as the force on the magnet assembly 1140, are being measured. The measurement may be made during manufacturing or testing of the movable magnet actuator valve 1100. In the same or other embodiments, such as those described with reference to FIGS. 9 and 12, the pole piece 950, 1250 can be thicker and therefore exert more pole force Fo on the magnet assembly 940, 1240, respectively. Additionally or alternatively, a diameter, such as the inner diameter of an opening in the pole piece 950, 1350 described with reference to FIGS. 9 and 13, can also be correlated with the desired pole force Fo.

With reference to embodiments that include the reluctance force Fr, such as the embodiment shown in FIG. 18, forming the movable magnet actuator valve 1800 can include positioning the magnet assembly 1840 and the magnetic circuit 1820. The positioning may be done so the positions of the magnet center and the zero bias point are the same as their respective design positions. For example, the magnet assembly 1840 can be positioned in the magnetic circuit 1820 so that the manufactured offset is about the same as the design offset. The magnet center CM can be positioned by the cumulative lengths (length being the dimension that is coaxial with the conduit axis X) of the magnet 1842, the seal 1844 and the encapsulation 1846. The zero bias point C0 can be positioned during formation of the magnetic circuit 1820.

The positioning can be done with an ultrasonic welding method. For example, the ultrasonic welding method can vibrate the valve body 1810 to induce friction heating between the bobbin 1860 and the valve body 1810. Due to the friction heating, an interface between the bobbin 1860 and the valve body 1810 begins to melt. While the interface is melted, the magnet center CM and the zero bias point C0 are moved to their respective design positions. Once the magnet center CM and the zero bias point C0 are at their respective design positions, the ultrasonic vibration is turned off to form a weld between the bobbin 1860 and the valve body 1810. In alternative embodiments, other parts, such as the magnetic circuit, can be welded to the valve body.

The embodiments described above provide a movable magnet actuator valve 100-1800 with a pole piece 150-1850. As explained in the foregoing, the magnet assembly 140-1840 in the movable magnet actuator valve 100-600 and 800-1800 can remain in the closed position with minimal to zero holding current. Accordingly, the magnet assembly 140-1840 may latch in place when opened or moved to the position closest to the pole piece 150-1850. The minimal to zero current can be due to the pole force Fo increasing the closer the magnet assembly 140-1840 gets to the pole piece 150-1850. In addition, a bias force Fb comprised of a reluctance force Fr and/or a spring force Fs can maintain the magnet assembly 140-1840 in the closed position or the position furthest away from the pole piece 150-1850. Maintaining the magnet assembly 140-1840 in the closed position can also require minimal to no holding current.

The detailed descriptions of the above embodiments are not exhaustive descriptions of all embodiments contemplated by the inventors to be within the scope of the present description. Indeed, persons skilled in the art will recognize that certain elements of the above-described embodiments may variously be combined or eliminated to create further embodiments, and such further embodiments fall within the scope and teachings of the present description. It will also be apparent to those of ordinary skill in the art that the above-described embodiments may be combined in whole or in part to create additional embodiments within the scope and teachings of the present description.

Thus, although specific embodiments are described herein for illustrative purposes, various equivalent modifications are possible within the scope of the present description, as those skilled in the relevant art will recognize. The teachings provided herein can be applied to other movable magnet actuator valves, and not just to the embodiments described above and shown in the accompanying figures. Accordingly, the scope of the embodiments described above should be determined from the following claims.

1. A movable magnet actuator valve (100-1800), comprising:
a valve body (110) comprised of a first fluid port (112-1812) and a second fluid port (114-1814);
an orifice (118-1818) that fluidly couples the first fluid port (112-1812) and the second fluid port (114-1814);
a coil assembly (130-1830) coupled to the valve body (110) and adapted to carry a current that forms a current induced magnetic field, wherein the coil assembly (1830) comprises two coils (1832a, 1832b);
a magnet assembly (140-1840) disposed in the coil assembly (130-1830) and adapted to move linearly in the coil assembly (130-1830) to selectively press against the orifice (118-1818); and
a pole piece (150-1850) adapted to form a pole force (Fo) on the magnet assembly (140-1840).

2. The movable magnet actuator valve (100-1800) of claim 1, further comprising a magnetic circuit (120-1820) surrounding the magnet assembly (140-1840), the magnetic circuit (120-1820) adapted to induce a reluctance force (Fr) on the magnet assembly (140-1840).

3. The movable magnet actuator valve (100-1800) of claim 1, wherein the pole force (Fo) holds the magnet assembly (140-1840) away from the orifice (118-1818) when the current in the coil assembly (130-1830) is about zero.

4. The movable magnet actuator valve (100-1800) of claim 1, further comprising a second orifice (1618b) fluidly coupled to the second fluid port (1614) wherein the pole force (Fo) presses the magnet assembly (1640) against the second orifice (1618b) when the current in the coil assembly (1630) is about zero.

5. The movable magnet actuator valve (100-1800) of claim 1, further comprising a bias spring (160) disposed between the magnet assembly (140) and the pole piece (150) that applies a spring force (Fs) to the magnet assembly (140).

6. The movable magnet actuator valve (100-1800) claim 1, wherein the coil assembly (1830) comprises a zero bias point (C0) of the magnet assembly (1840) is between the two coils (1832a, 1832b).

7. The movable magnet actuator valve (1800) of claim 6, wherein the zero bias point (C0) of the magnet assembly (1840) is approximately equidistant between the two coils (1832a, 1832b).

8. The movable magnet actuator valve (100-1800) of claim 1, further comprising a bobbin (170) disposed between the magnetic circuit (120) and the magnet assembly (140), wherein the bobbin (170) is adapted to hold the coil assembly (130).

9. The movable magnet actuator valve (100-1800) of claim 1, wherein the magnet assembly (140-1840) comprises a magnet (142-1842) coupled to a seal (144-1844), wherein the magnet (142-1842) presses the seal (144-1844) against the first orifice (118-1818) or the second orifice (1618b).

10. A method of controlling fluid through a movable magnet actuator valve, the method comprising:
providing a movable magnet actuator valve, comprising:
a valve body comprised of a first fluid port and a second fluid port;
an orifice that fluidly couples the first fluid port and the second fluid port;
a coil assembly coupled to the valve body and adapted to carry a current that forms a current induced magnetic field, wherein the coil assembly comprises two coils;
a magnet assembly disposed in the coil assembly and adapted to move linearly in the coil assembly to selectively press against the orifice; and
a pole piece adapted to form a pole force (Fo) on the magnet assembly;
forming the current induced magnetic field that applies a current induced force to the magnet assembly to displace the magnet assembly away from the first orifice; and
forming the pole force on the magnet assembly with the pole piece that retains the magnet assembly in a position displaced away from the first orifice.

11. The method of controlling fluid through the movable magnet actuator valve of claim 10, further comprising pressing the magnet assembly against a second fluid orifice with the pole force.

12. The method of controlling fluid through the movable magnet actuator valve of claim 10, further comprising reducing the current induced force to approximately zero when the magnet assembly is displaced away from the first orifice.

13. The method of controlling fluid through the movable magnet actuator valve of claim 10, further comprising biasing the magnet assembly towards the first orifice with a spring force.

14. The method of controlling fluid through the movable magnet actuator valve of claim 10, further comprising biasing the magnet assembly towards the first orifice with a reluctance force.

15. A method of forming a movable magnet actuator valve (100-1800), the method comprised of:
providing a movable magnet actuator valve, comprising:
a valve body comprised of a first fluid port and a second fluid port;
an orifice that fluidly couples the first fluid port and the second fluid port;
a coil assembly coupled to the valve body and adapted to carry a current that forms a current induced magnetic field, wherein the coil assembly comprises two coils;
a magnet assembly disposed in the coil assembly and adapted to move linearly in the coil assembly to selectively press against the orifice; and
a pole piece adapted to apply a pole force (Fo) on the magnet assembly;
wherein the magnet assembly (140-1840) is movable relative to the orifice (118-1818) to selectively fluidly couple the first fluid port (112-1812) and the second fluid port (114-1814); and
measuring the pole force while positioning the magnet assembly (140-1840).

16. The method of forming the movable magnet actuator valve (100-1800) of claim 15, further comprising positioning the pole piece (150-1850) relative to the magnet assembly (140-1840) such that the pole force retains the magnet assembly (140-1840) in a position away from the orifice (118-1818) when a current induced force is not applied to the magnet assembly (118-1818).

17. The method of forming the movable magnet actuator valve (100-1800) of claim 15, further comprising applying a bias force that presses the magnet assembly towards the orifice (118-1818).

18. The method of forming the movable magnet actuator valve (100-1800) of claim 17, wherein the bias force is comprised of a reluctance force of a magnetic circuit (120-1820) that surrounds the magnet assembly (140-1840).

19. The method of forming the movable magnet actuator valve (100-1800) of claim 17, wherein the bias force is comprised of a spring force applied to the magnet assembly (140) by a spring (160).

20. The moveable actuator valve of claim 1, wherein the second coil of the two coils surrounds the second end of the magnet assembly, the second end of the magnet assembly being opposite the first end.

21. The moveable actuator valve of claim 1, wherein the coils extend in an axial direction beyond the magnet assembly.
